(19) United States
(12) Patent Application Publication
(10) Pub. No.: US 2015/0003405 A1
(43) Pub. Date: Jan. 1, 2015

(54) Enhanced Broadcast Channel for Primary System Information acquisition in OFDM/OFDMA Systems

(71) Applicant: MEDIATEK INC., Hsinchu (TW)

(72) Inventors: Pei-Kai Liao, Nantou County (TW); Xiangyang Zhuang, Lake Zurich, IL (US)

(21) Appl. No.: 14/315,072

(22) Filed: Jun. 25, 2014

Related U.S. Application Data
(60) Provisional application No. 61/839,524, filed on Jun. 26, 2013.

(51) Int. Cl. H04L 5/00

(52) U.S. Cl. CPC H04L 5/0053
USPC 370/330; 370/329

(57) ABSTRACT

New enhanced physical broadcast channel (EPBCH) based on UE-specific reference signals (DMRS) for MIB and SIB transmission is proposed. The overall design consideration for EPBCH can be summarized as follows: support different values of frequency reuse factor, support different cell coverage sizes, maximized diversity gain in open-loop operation such as transmit diversity and frequency diversity, minimized overhead, and minimized UE complexity.

### CROSS REFERENCE TO RELATED APPLICATIONS

This application claims priority under 35 U.S.C. §119 from U.S. Provisional Application No. 61/839,524, entitled “Enhanced Broadcast Channel for Primary System Information Acquisition in OFDM/OFDMA Systems,” filed on Jun. 26, 2013, the subject matter of which is incorporated herein by reference.

### TECHNICAL FIELD

The disclosed embodiments relate generally to enhanced physical broadcast channel (ePBCH), and, more particularly, to ePBCH transmission and ePBCH search space definition in OFDM/OFDMA systems.

### BACKGROUND

In 3GPP Long-Term Evolution (LTE) networks, an evolved universal terrestrial radio access network (E-UTRAN) includes a plurality of base stations, e.g., evolved Node-Bs (eNBs) communicating with a plurality of mobile stations referred as user equipment (UEs). Orthogonal Frequency Division Multiple Access (OFDMA) has been selected for LTE downlink (DL) radio access scheme due to its robustness to multipath fading, higher spectral efficiency, and bandwidth scalability. Multiple access in the downlink is achieved by assigning different sub-bands (i.e., groups of subcarriers, denoted as resource blocks (RBs)) of the system bandwidth to individual users based on their existing channel condition.

For trade-off between transmission overhead and connection delay, system information is divided into several blocks in LTE systems, each of which has different periodicities. Master information block (MIB) is one of system information blocks (SIBS) and contains information of downlink cell bandwidth, system frame number (SFN), physical HARQ indicator channel (PHICH) configuration and the number of transmit antenna ports. MIB is carried in physical broadcast channel (PBCH), which is transmitted every radio frame with a fixed periodicity of four radio frames. PBCH relies on cell-specific reference signal (CRS) for demodulation at UE side and UE can determine the number of transmit antenna ports through the blind decoding on CRS and further confirmation with MIB content. CRS is a kind of common pilots that are always transmitted in whole channel bandwidth in every subframe no matter whether there is data transmission.

In 3GPP Release 11 LTE systems, an additional carrier type is specified for the following benefits: efficient bandwidth utilization, overhead reduction and energy efficiency, soft GSM to LTE frequency band refarming, more efficient eMBMS, support of FDM ICIC in HetNet, and support of MTC. To support above benefits, it was first agreed that CRS could be removed completely or partially in the additional carrier type. A new carrier type (NCT) is generally categorized into stand-alone and non-stand-alone. For non-stand-alone NCT, there is no system information broadcast on it so it cannot be used by UEs as a component carrier for network entry and a primary cell in carrier aggregation without any legacy carrier. For stand-alone NCT, there is system information broadcast on it so it can be utilized by UEs as a component carrier for network entry and a primary cell in carrier aggregation without any legacy carrier. To support system information broadcast on stand-alone NCT, traditional cell-specific reference signal (CRS) based physical broadcast channel (PBCH) is no longer feasible. Existing physical container PBCH for MIB requires CRS for demodulation but there are no CRSS in the NCT in LTE. New enhanced physical container (EPBCH) based on UE-specific reference signals (DMRS) for MIB and SIB transmission is needed.

Similar problem has occurred in traditional physical downlink control channel (PDCCH). Due to the issue of downlink control capacity, it was agreed that an enhanced physical downlink control channel (ePDCCH) spans both first and second slots in the region of legacy PDSCH. Various proposals have been made related to the design of ePDCCH. In U.S. patent application Ser. No. 13/927,113, entitled “Physical Structure and Reference Signal Utilization of Enhanced Physical Downlink Control Channel for OFDM/OFDMA systems”, filed on Jun. 26, 2013, the physical structure of ePDCCH is discussed, the subject matter of which is incorporated herein by reference. In U.S. patent application Ser. No. 13/847,619, entitled “Method for Search Space Configuration of Enhanced Physical Downlink Control Channel”, filed on Mar. 20, 2013, a solution to aggregate the assigned physical radio resources for both distributed and localized transmission schemes of ePDCCH and configure common and UE-specific search space for each UE is proposed, the subject matter of which is incorporated herein by reference. In U.S. patent application Ser. No. 13/889,554, entitled “Methods for Resource Multiplexing of Distributed and Localized Transmission in Enhanced Physical Downlink Control Channel”, filed on May 8, 2013, a method to multiplexing physical radio resources for both distributed and localized transmission of ePDCCH in a set of physical resource blocks (PRBs) is provided, the subject matter of which is incorporated herein by reference.

### SUMMARY

New enhanced physical broadcast channel (EPBCH) based on UE-specific reference signals (DMRS) for MIB and SIB transmission is proposed. The overall design consideration for EPBCH can be summarized as follows: support different values of frequency reuse factor, support different cell coverage sizes, maximized diversity gain in open-loop operation such as transmit diversity and frequency diversity, minimized overhead, and minimized UE complexity.

In one embodiment, a UE in a serving cell receives a set of radio resources reserved for EPBCH transmission in a set of specific subframes. The set of radio resources is reserved for primary system information broadcasting in the serving cell based on a first predetermined rule. The UE determines a set of candidate EPBCHs within the reserved radio resources based on a second predetermined rule. Each EPBCH candidate is associated with a set of resource units. The UE then collects a plurality of resource elements for each resource unit, and decodes the primary system information from one or more detected EPBCH transmission in the set of EPBCH candidates. The detection of EPBCH transmission is determined by a successful decoding of the primary system information.

In another embodiment, a base station reserves a set of radio resources for EPBCH transmission in a set of specific subframes. The set of radio resources is reserved for EPBCH transmission of primary system information broadcasting in a serving cell based on a first predetermined rule. The base station allocates a set of EPBCH candidates within the reserved radio resources based on a second predetermined rule. Each EPBCH candidate is associated with a set of resource units. Finally, the base station encodes the primary system information over the corresponding set of resource units to be transmitted in the set of specific subframes.

Other embodiments and advantages are described in the detailed description below. This summary does not purport to define the invention. The invention is defined by the claims.

### BRIEF DESCRIPTION OF THE DRAWINGS

The accompanying drawings, where like numerals indicate like components, illustrate embodiments of the invention.

FIG. 1A (Prior Art) illustrates two examples for both normal and extended CP in 3GPP LTE systems based on OFDMA downlink.

FIG. 1B (Prior Art) illustrates the relative locations of PSS/SSS, CRS, and PBCH within a PRB pair.

FIG. 2A illustrates a mobile communication system with enhanced broadcast channel (EPBCH) for primary system information in accordance with one novel aspect.

FIG. 2B illustrates simplified block diagrams of a base station and a user equipment in accordance with embodiments of the present invention.

FIG. 3 illustrates EPBCH spanning in frequency domain only.

FIG. 4 illustrates EPBCH spanning in both time and frequency domain.

FIG. 5 illustrates EREG and ECCE based physical structure for EPBCH candidate definition utilizing six PRB pairs.

FIG. 6 illustrates EREG and ECCE based physical structure for EPBCH candidate definition utilizing two distant PRB pairs.

FIG. 7 illustrates EREG and ECCE based physical structure for EPBCH candidate definition utilizing four PRB pairs.

FIG. 8 illustrates EREG and ECCE based physical structure for EPBCH candidate definition utilizing three sets of PRB pairs.

FIG. 9 illustrates EREG or ECCE resource unit based physical structure for EPBCH candidate definition utilizing six PRB pairs.

FIG. 10 illustrates EREG or ECCE resource unit based physical structure for EPBCH candidate definition utilizing two distant PRB pairs.

FIG. 11 illustrates EREG or ECCE resource unit based physical structure for EPBCH candidate definition utilizing three sets of PRB pairs.

FIG. 12 illustrates PRB pair based physical structure for EPBCH candidate definition.

FIG. 13 illustrates different EPBCH search spaces in logic resource unit domain.

FIG. 14 illustrates different EPBCH search spaces in PRB pair domain.

FIG. 15 is a flow chart of a method of receiving and decoding primary system information using EPBCH in accordance with one novel aspect.

FIG. 16 is a flow chart of a method of encoding and transmitting primary system information using EPBCH in accordance with one novel aspect.

### DETAILED DESCRIPTION

Reference will now be made in detail to some embodiments of the invention, examples of which are illustrated in the accompanying drawings.

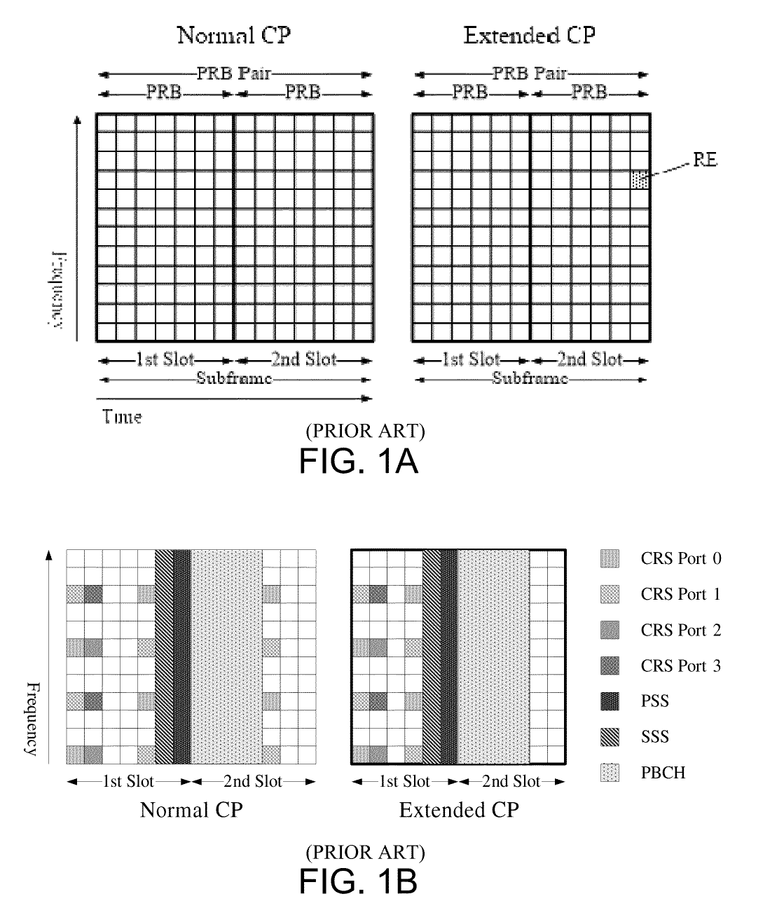

In 3GPP LTE systems based on OFDMA downlink, the radio resource is partitioned into radio frames, each of which consists of ten subframes. Each subframe has a time length of 1 ms and is comprised of two slots and each slot has seven OFDMA symbols along time domain of normal cyclic prefix (CP) and six OFMAS symbols in case of extended CP. Each OFDMA symbol further consists of a number of OFDMA subcarriers along frequency domain depending on the system bandwidth. The basic unit of the resource grid is called Resource Element (RE), which spans an OFDMA subcarrier over one OFDMA symbol. A physical resource block (PRB) occupies one slot and twelve subcarriers, which constitutes 84 REs in normal CP and 72 REs in extended CP. Two PRBs locating in the same frequency location spans in different slots within a subframe is called a PRB pair. FIG. 1A (Prior Art) illustrates two examples of PRB and PRB pair for both normal CP and extended CP in 3GPP LTE systems based on OFDMA downlink.

When an UE is turned on in a cell or handovers to a cell, it performs downlink synchronization and system information acquisition before conducting random access process to get RRC-layer connected. Downlink synchronization is performed by an UE with primary and secondary synchronization signals (PSS and SSS) to synchronize the carrier frequency and align OFDM symbol boundary between the base station of a cell and an UE. Further frequency and timing fine-tune or tracking is carried out continuously with cell-specific reference signal (CRS) by an UE. CRS is a kind of common pilots that are always transmitted in whole channel bandwidth in every subframe no matter whether there is data transmission. When there is data transmission, CRS is not precoded with a MIMO precoder even if MIMO precoding is applied. In addition to frequency and time fine-tune, CRS is also utilized for the coherent data demodulation. After an UE gets downlink synchronized, system information acquisition is the next step to obtain necessary information for random access and connection/service settings.

For trade-off between transmission overhead and connection delay, system information is divided into several blocks in LTE systems, each of which has different periodicities. Master information block (MIB) is one of system information blocks (SIBS) and contains information of downlink cell bandwidth, system frame number (SFN), physical HARQ indicator channel (PHICH) configuration and the number of transmit antenna ports. MIB is carried in physical broadcast channel (PBCH), which is transmitted every radio frame with a fixed periodicity of four radio frames. After obtaining MIB, UE is able to obtain SIB1 and other SIBS for further system setting. SIB1 and other SIBS are carried in physical downlink shared channel (PDSCH), which is scheduled by physical downlink control channel (PDCCH). SIB1 is transmitted every second radio frame with a fixed periodicity of eight radio frames, while other SIBS have variable periodicity configurations configured in SIB1.

In Release 8/9/10/11 LTE systems, PBCH spans four OFDMA symbols with the middle six PRB pairs in subframe #0 every radio frame. PBCH relies on cell-specific reference signal (CRS) for demodulation at UE side and UE can determine the number of transmit antenna ports through the blind decoding on CRS and further confirmation with MIB content. FIG. 1B (Prior Art) illustrates the relative locations of PSS/SSS, CRS, and PBCH within a PRB pair for both normal and extended CP.

In Release 12 LTE systems, New Carrier Type (NCT) is considered as a candidate feature to further enhance the spectral efficiency, inter-cell interference, eNB power efficiency, and services such as Multimedia Broadcast and Multicast Service (MBMS) and Machine Type Communication (MTC). In NCT, there is only reduced CRS (CRS port 0 only) every five subframes and will not be used for demodulation. Thus, CRS-based PBCH does not work anymore. In addition to CRS, UE-specific reference signals (DMRS), which are a kind of dedicated pilots, are also specified in Release 8/9/10/11 LTE systems. Compared to CRS, DMRS is only transmitted in the radio resources where there is data transmission and it is precoded with the same MIMO precoder together with the data tones for a specific UE if MIMO precoding is applied and it is mainly utilized for coherent data demodulation. Due to the lack of CRS for demodulation in NCT, DMRS-based PBCH is inevitable. For differentiation, DMRS-based PBCH is referred to as enhance physical broadcast channel (EPBCH).

Because LTE supports up to 6 channel bandwidth (1.4, 3, 5, 10, 15, 20 MHz) currently, and PSS/SSS does not carry the information of downlink cell bandwidth, UE does not know which channel bandwidth the detected cell supports even after downlink synchronization. Like PBCH, EPBCH remains to reside within the minimal channel bandwidth LTE supports. For better performance, it is usually preferred to design a physical channel to enjoy transmit diversity, frequency diversity, or both in open-loop operation without channel state information. Therefore, it is preferable to span the EPBCH over the whole channel bandwidth it can utilize as much as possible. In addition, there will be severe interference in the future cellular system, such as HetNet or small cell environment, which consists of different overlaying cell types with different cell coverage sizes (e.g. macrocell, microcell, picocell and femtocell). Therefore, it is also better to provide a flexible design to support different values of frequency reuse factor and different cell coverage sizes. The overall design consideration for EPBCH can be summarized as follows: support different values of frequency reuse factor, support different cell coverage sizes, maximized diversity gain in open-loop operation such as transmit diversity and frequency diversity, minimized overhead, and minimized UE complexity.

To support different values of frequency reuse factor, EPBCH should be able to be transmitted in the same or different radio resources based on eNB's coordination with neighboring eNBs or cell planning. To achieve this, several EPBCH candidates for cells are defined within the supported channel bandwidth for EPBCH transmission in some specific subframes (e.g. subframe #0 within a radio frame in LTE). An EPBCH candidate is the candidate radio resource that spans in either the frequency domain only or both the frequency and time domain and may be utilized for actual EPBCH transmission. Each EPBCH candidate may reside within orthogonal, partially overlapping or fully overlapping radio resources with others. Since which EPBCH candidate will be used for EPBCH transmission by an eNB is unknown to an UE, UE needs to blindly detect EPBCH transmission on different EPBCH candidates. More predefined EPBCH candidates introduce higher complexity of UE blind decoding. On the contrary, it also brings more flexibility to an eNB to select appropriate radio resources for efficient EPBCH transmission based on the interference environment.

To support different cell coverage sizes with the best resource utilization efficiency, EPBCH candidates using different sizes of radio resources are supported. More radio resources used for EPBCH transmission introduce lower coding rate for the information carried in EPBCH and thus provide either better decoding reliability or larger cell coverage. For simplicity, only several specific sizes of radio resources are utilized for EPBCH transmission and each specific size of radio resources consists of an integer number of resource units. Each resource unit contains a block of radio resources. The specific sizes of radio resources (i.e., the number of resource units) are called aggregation levels and each EPBCH candidate has its own aggregation level.

To support maximal diversity gain, the radio resources utilized by each EPBCH candidate are distributed in either the frequency domain only or both the frequency and time domain over the radio resources within the supported channel bandwidth for EPBCH transmission in specific subframes, instead of a block of contiguous radio resources. Furthermore, transmit diversity schemes, such as space-frequency block code, frequency shift transmit diversity (FSTD) and random beamforming, can be utilized together with distributed transmission of EPBCH for better decoding reliability or larger cell coverage. If the radio resources for EPBCH transmission span small time-frequency dimension, diversity gain introduced by the distributed transmission may be limited. Considering blind decoding performance and the complexity of EPBCH and PDSCH resource multiplexing within a PRB pair, localized transmission of EPBCH is preferred in this case. Transmit diversity schemes, such as space-frequency block code (SFBC) and FSTD, can be utilized together with localized transmission of EPBCH for better decoding reliability or larger cell coverage.

Since system information acquisition is useful only for initial network entry, network re-entry and handover, the overhead to carry system information should be minimized without introducing large latency for system information acquisition. To achieve this, system information is divided into two types, primary system information (e.g., MIB in LTE) and secondary system information (e.g., SIBs in LTE). Primary system information includes minimal system information set which is necessary for the required physical layer processing between the downlink synchronization and the acquisition of secondary system information, e.g. channel bandwidth. Secondary system information includes all the remaining system information and may be divided into several blocks to further enhance the transmission efficiency. For the best trade-off between system information acquisition latency and overhead, primary system information has a shorter update periodicity than that for secondary system information.

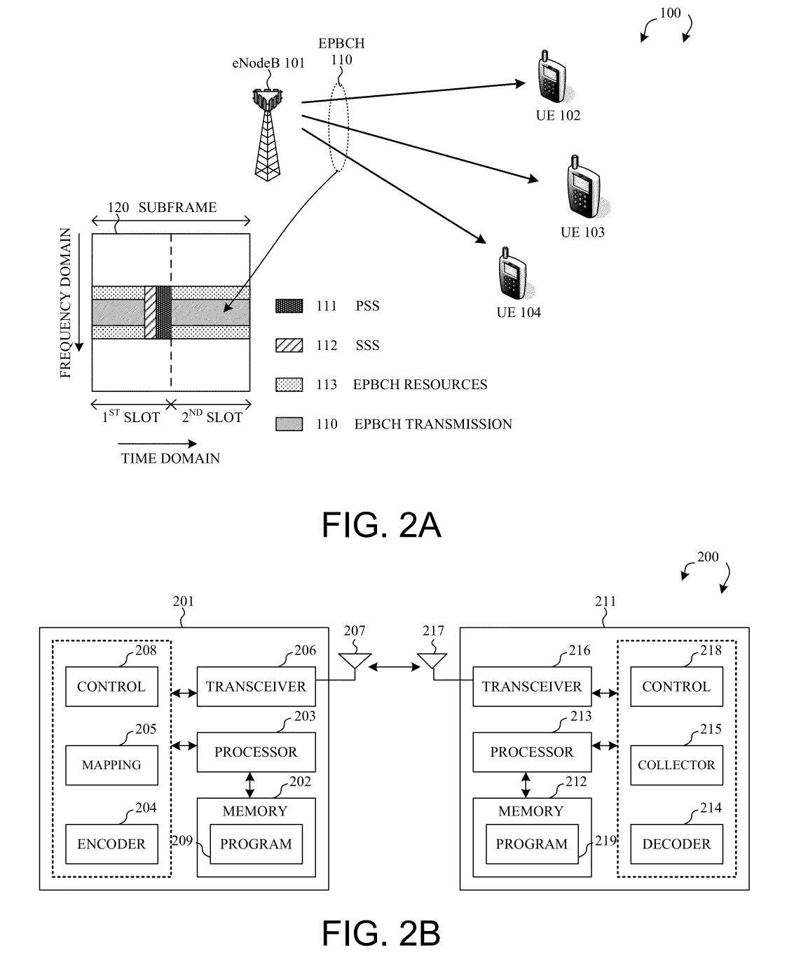

FIG. 2A illustrates a mobile communication system 100 with enhanced broadcast channel (EPBCH) for primary system information in accordance with one novel aspect. Mobile communication system 100 is an OFDM/OFDMA LTE system comprising a base station eNodeB 101 and a plurality of user equipments (UEs) UE 102, UE 103, and UE 104. FIG. 2A illustrates one example of an EPBCH 110 for broadcasting primary system information. In subframe 120 (e.g., subframe #0) within a radio frame, Block 111 depicts the radio resources allocated for PSS, block 112 depicts the radio resource allocated for SSS, and block 113 depicts the radio resource allocated for EPBCH.

In the example of FIG. 2A, block 113 reserved for EPBCH occupies a plurality of PRB pairs in one subframe. Within the reserved radio resource 113, eNB 101 can configured a set of candidate EPBCHs. Each EPBCH candidate is distributed in frequency domain, which occupies the same subcarriers as occupied by PSS and SSS in frequency domain. In other examples, block 113 may consists of different subframes aggregated together, and each EPBCH candidate may be distributed in time domain. Primary system information can be carried in one or multiple EPBCH transmission and broadcasted from eNB 101 to UE 102, UE 103, and UE 104. From receiving side, each UE detects EPBCH transmission 110 from the set of EPBCH candidates. The detection of the EPBCH transmission is determined by a successful decoding of the primary system information, e.g., by the correctness of the cyclic redundancy checking (CRC) bits for the primary system information.

FIG. 2B illustrates simplified block diagrams of a base station eNB 201 and a user equipment UE 211 in accordance with embodiments of the present invention. For base station 201, antenna 207 transmits and receives radio signals. RF transceiver module 206, coupled with the antenna, receives RF signals from the antenna, converts them to baseband signals and sends them to processor 203. RF transceiver 206 also converts received baseband signals from the processor, converts them to RF signals, and sends out to antenna 207. Processor 203 processes the received baseband signals and invokes different functional modules to perform features in base station 201. Memory 202 stores program instructions and data 209 to control the operations of the base station.

Similar configuration exists in UE 211 where antenna 217 transmits and receives RF signals. RF transceiver module 216, coupled with the antenna, receives RF signals from the antenna, converts them to baseband signals and sends them to processor 213. The RF transceiver 216 also converts received baseband signals from the processor, converts them to RF signals, and sends out to antenna 217. Processor 213 processes the received baseband signals and invokes different functional modules to perform features in UE 211. Memory 212 stores program instructions and data 219 to control the operations of the UE.

Base station 201 and UE 211 also include several functional modules to carry out some embodiments of the present invention. The different functional modules can be implemented by software, firmware, hardware, or any combination thereof. The function modules, when executed by the processors 203 and 213 (e.g., via executing program codes 209 and 219), for example, allow base station 201 to encode and transmit primary system information to UE 211, and allow UE 211 to receive and decode the primary system information accordingly.

In one example, base station 201 configures a set of radio resource for EPBCH transmission via control module 208 and maps the primary system information to the configured PRB pairs, resource units and resource elements via mapping module 205. The primary system information carried in EPBCCH is then modulated and encoded via encoder 204 to be transmitted by transceiver 206 via antenna 207. UE 211 receives the primary system information by transceiver 216 via antenna 217. UE 211 determines the configured radio resource and candidate EPBCHs for EPBCCH transmission via control module 218 and collects the configured PRB pairs, resource units and resource elements via collector 215. UE 211 then demodulates and decodes the primary system information from the collected resource elements via decoder 214.

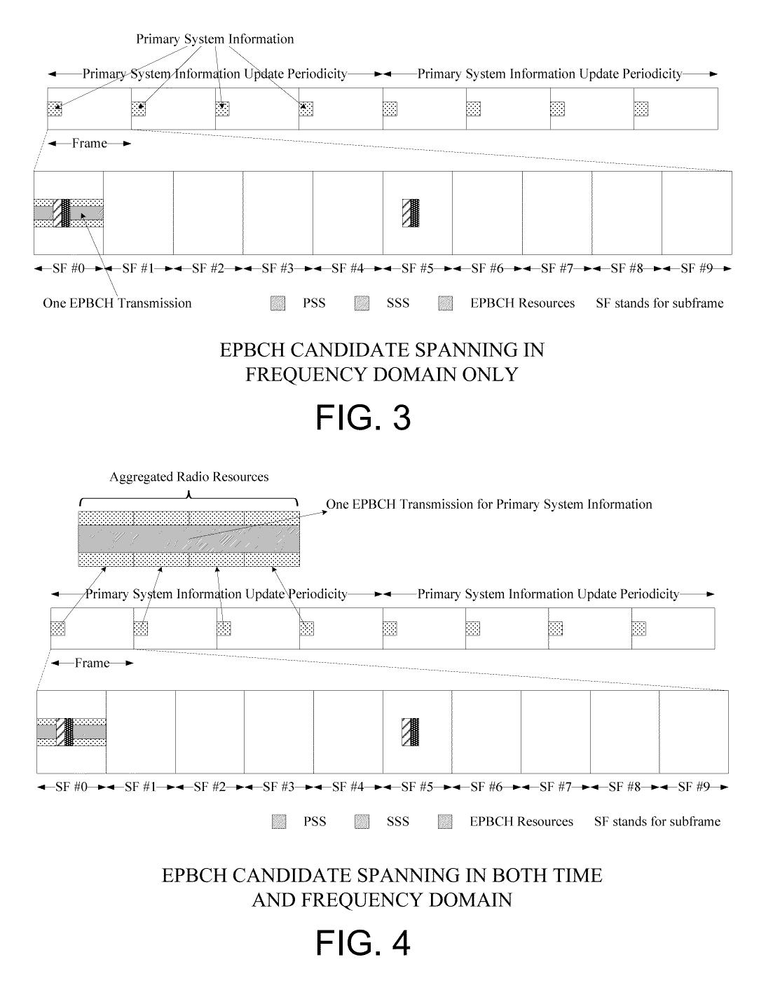

FIG. 3 illustrates EPBCH spanning in frequency domain only. When an EPBCH candidate spans in frequency domain only and one EPBCH transmission corresponds to the transmission of EPBCH in a specific subframe, the primary system information can be carried in multiple EPBCH transmissions that spread in time domain to obtain more radio resources for better reliability. In other words, one primary system information transmission requires multiple EPBCH transmissions in this case. The subframes where there is EPBCH transmission are determined according to a predefined rule. The duration between two consecutive subframes with EPBCH transmissions can be either a fixed value or a variable based on a predefined rule. For simplicity, EPBCH transmissions for one primary system information update utilize the same EPBCH candidate in frequency domain. For better frequency diversity, EPBCH transmissions for one primary system information update utilize different EPBCH candidates in frequency domain based on a predefined hopping rule. In the example of FIG. 3, the primary system information is carried in four EPBCH transmissions and each EPBCH transmission occurs in subframe #0 within a frame.

FIG. 4 illustrates EPBCH spanning in both time and frequency domain. When an EPBCH candidate spans in both frequency and time domain and one EPBCH transmission corresponds to the transmission of EPBCH within the update periodicity of the primary system information, the primary system information can be carried in one EPBCH transmission due to larger radio resources for one EPBCH candidate. The subframes where there are radio resources reserved for EPBCH transmission are determined according to a predefined rule. The duration between two consecutive subframes with EPBCH transmissions can be either a fixed value or a variable based on a predefined rule. The radio resources within the supported channel bandwidth for EPBCH transmission in multiple specific subframes that are in the update periodicity of the primary system information are aggregated for the definition of EPBCH candidates. In the example of FIG. 4, reserved radio resources for EPBCH transmission in four subframes (e.g., subframe #0) from four consecutive radio frames are first aggregated together. Candidate EPBCHs are then defined from the aggregated radio resources. The primary system information is carried in an EPBCH transmission spanning over the aggregated radio resources within the supported channel bandwidth for EPBCH transmission and the update periodicity of the primary system information.

### EREG Plus ECCE Based EPBCH Physical Structure

In one embodiment, two levels of physical structure are defined for better diversity for both distributed and localized transmission in EPBCH. Enhanced control channel element (ECCE), which is utilized for the definition of Release 11 EPDCCH, is utilized as a basic unit to define an EPBCH candidate. The radio resources for EPBCH candidate definition can be those within the supported channel bandwidth for EPBCH transmission in a specific subframe or the aggregated ones within the supported channel bandwidth for EPBCH transmission in multiple specific subframes that are in the update periodicity of the primary system information. Within the radio resources for EPBCH candidate definition, PRB pairs are first partitioned into enhance resource element groups (EREGs) (e.g., 16 EREGs) and then each ECCE is composed of several EREGs (e.g. four EREGs in Release 11 LTE system).

For better diversity, distributed ECCE, which consists of EREGs in different PRB pairs, are used for EPBCH transmission. For the case where the radio resources for EPBCH candidate definition are those within the supported channel bandwidth for EPBCH transmission in a specific subframe, localized ECCE, which consists of EREGs within a PRB pair, can be used for EPBCH transmission without the large loss of frequency diversity gain if the supported channel bandwidth for EPBCH transmission is small.

Within the radio resources for EPBCH candidate definition, several EPBCH candidates are defined based on the physical structure of EREG plus ECCE and each candidate EPBCH has its own aggregation level utilizing ECCE as the basic unit. Therefore, within a PRB pair, there may be remaining REs that are not utilized for EPBCH transmission, especially for EPBCH transmission using distributed ECCEs. Based on the cell coverage size, the supported EPBCH aggregation level(s) can be different. For example, EPBCH aggregation level can be eight ECCEs for a macrocell and two ECCEs for a picocell.

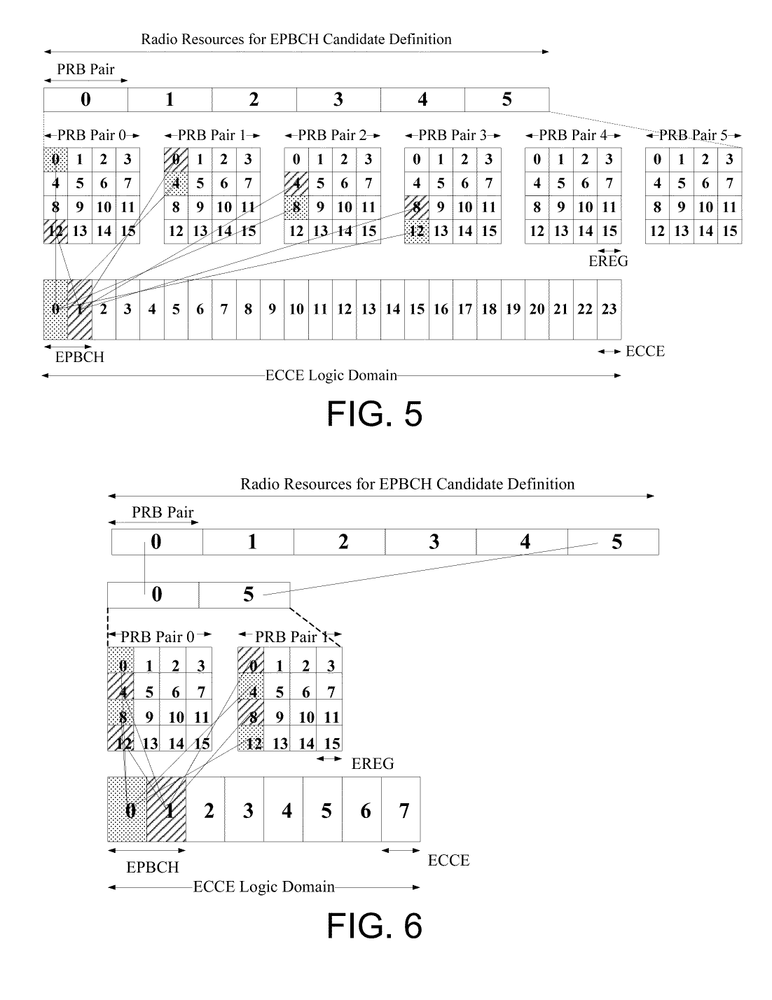

FIG. 5 illustrates EREG and ECCE based physical structure for EPBCH candidate definition utilizing six PRB pairs. In the example of FIG. 5, the six PRB pairs are reserved for EPBCH transmission, and the difference between two PRB-pairs indices determines their time-frequency distance. These six PRB pairs can be aggregated from the radio resources within the supported channel bandwidth in multiple specific subframes in the update periodicity of the primary system information. The six PRB pairs are not limited to the middle six PRB pairs in a specific subframe only. Each PRB pair consists of 16 EREGs, while each ECCE consists of four EREGs. Though the remaining REs that are not utilized for EPBCH transmission can be utilized for PDSCH transmission, it may degrade the performance of EPBCH blind decoding.

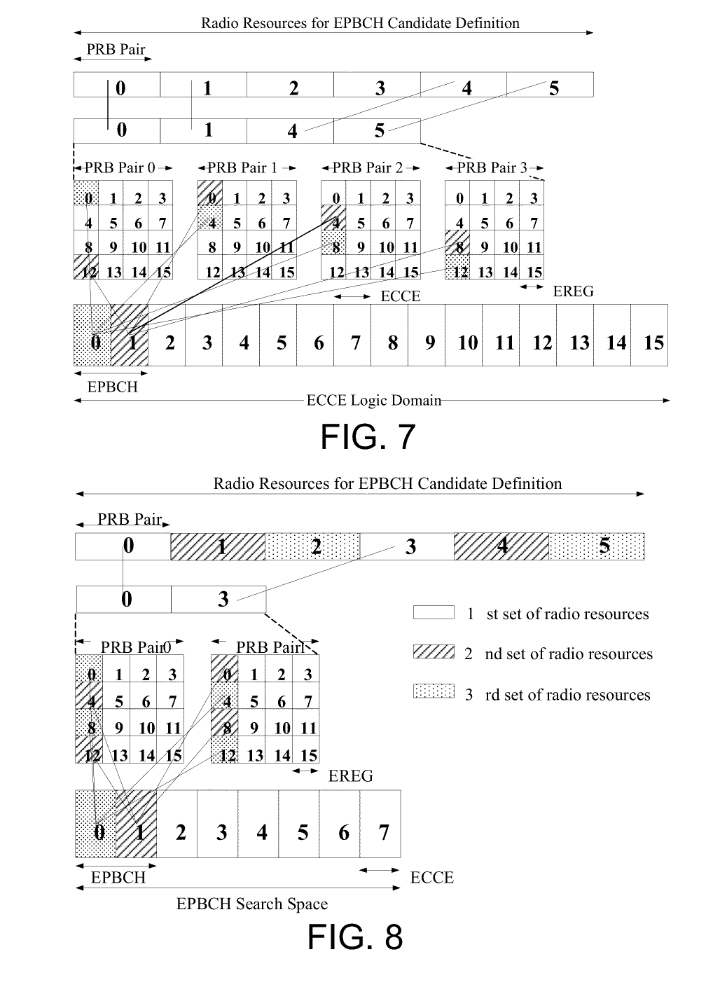

To avoid the performance degradation and improve resource utilization efficiency, less number of PRB pairs can be utilized for EPBCH candidate definition. FIG. 6 illustrates EREG and ECCE based physical structure for EPBCH candidate definition utilizing two distant PRB pairs. FIG. 7 illustrates EREG and ECCE based physical structure for EPBCH candidate definition utilizing four PRB pairs. The difference between two PRB-pairs indices determines their time-frequency distance. In FIGS. 6 and 7, the utilized PRB pairs (e.g., utilized PRB pairs 0 and 5 in FIG. 6, and utilized PRB pairs 0, 1, 4, and 5 in FIG. 7) reside in distant physical locations to maximize the diversity. However, this will reduce frequency reuse rate and thus may degrade decoding performance in interference-limited environment.

FIG. 8 illustrates EREG and ECCE based physical structure for EPBCH candidate definition utilizing three sets of PRB pairs. Grouping EPBCH candidates in ECCE logic domain can reduce the blind decoding complexity of an UE. However, it may either require the multiplexing of EPBCH and PDSCH within a PRB pair or sacrifice frequency reuse rate to improve resource utilization efficiency. It would introduce additional complexity for PDSCH rate matching around EPBCH or performance degradation of EPBCH decoding. To avoid this, EPBCH candidates can also be separated for each cell in PRB-pair domain in addition to ECCE logic domain.

In the example of FIG. 8, three sets of PRB pairs (e.g., first set of PRB pairs 0 and 3, second set of PRB pairs 1 and 4, and third set of PRB pairs 2 and 5) are defined to accommodate EPBCH candidates and the difference between two PRB-pairs indices determines their time-frequency distance. Each set of PRB pairs may contain EPBCH candidates for single or multiple cells. When one set of PRB pairs is utilized for EPBCH transmission in a cell, the other two set of PRB pairs can be used for PDSCH transmission in the same cell. If there are unused radio resources for PBCH transmission within a set of PRB pairs, multiplexing of EPBCH and PDSCH within a PRB pair can be supported or not supported without large loss of resource utilization efficiency.

### EREG or ECCE Based EPBCH Physical Structure

In one embodiment, one level of physical structure is defined for both distributed and localized transmission in EPBCH. A block of radio resources within a PRB pair, either EREG or localized ECCE, is utilized as a basic unit to define an EPBCH candidate and there may be several EREGs or localized ECCEs in a PRB pair. Within the radio resources for EPBCH candidate definition, PRB pairs are partitioned into EREGs or localized ECCEs. EPBCH candidates are defined based on the physical structure of EREG or localized ECCE and each EPBCH candidate has its own aggregation level utilizing EREG or localized ECCE as the basic unit. If the radio resources for EPBCH candidate definition span large enough time-frequency dimension, it is preferred to utilize EREGs or localized ECCEs across different distant PRB pairs in time-frequency domain for EPBCH transmission to support larger diversity. On the other hand, if the radio resources for EPBCH candidate definition span small time-frequency dimension, it is preferred to utilize EREGs or localized ECCE within one or nearby PRB pairs in time-frequency domain for EPBCH transmission to have a simple physical mapping design. Based on the cell coverage size, the supported EPBCH aggregation level(s) can be different.

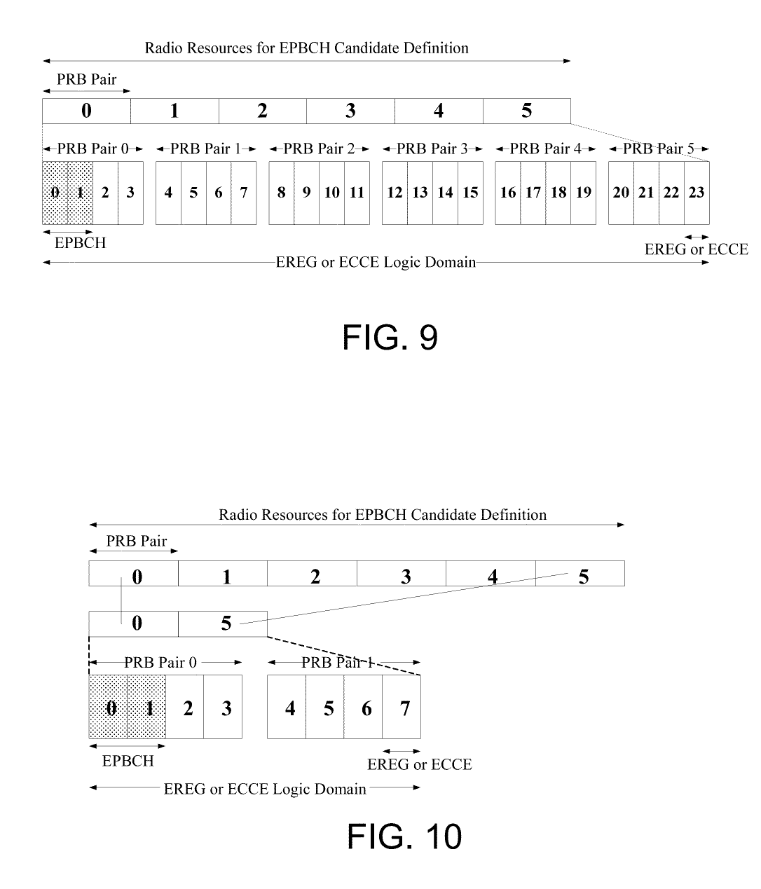

FIG. 9 illustrates EREG or ECCE resource unit based physical structure for EPBCH candidate definition utilizing six PRB pairs. The difference between two PRB-pairs indices determines their time-frequency distance. In FIG. 9, grouping EPBCH candidates to reduce the blind decoding complexity of an UE is done in EREG or ECCE logic domain only. Example illustrated in FIG. 9 optimizes for the robustness in interference-limited environment by providing more selections of frequency reuse rates.

FIG. 10 illustrates EREG or ECCE resource unit based physical structure for EPBCH candidate definition utilizing two distant PRB pairs. The difference between two PRB-pairs indices determines their time-frequency distance. In FIG. 10, grouping EPBCH candidates to reduce the blind decoding complexity of an UE is done in EREG or ECCE logic domain only. Example illustrated in FIG. 10 optimizes for resource utilization efficiency by sacrificing selections of frequency reuse rates.

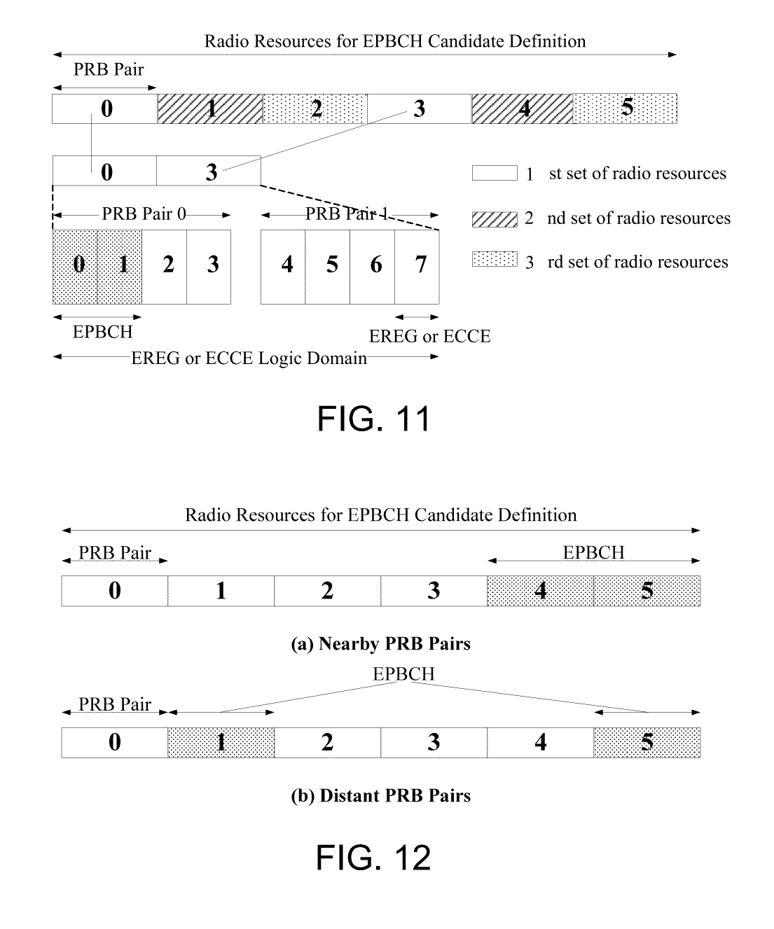

FIG. 11 illustrates EREG or ECCE resource unit based physical structure for EPBCH candidate definition utilizing three sets of PRB pairs. In FIG. 11, grouping EPBCH candidates to reduce the blind decoding complexity of an UE is also done in PRB-pair domain in addition to EREG or ECCE logic domain. Example illustrated in FIG. 11 shows good balance between the robustness in interference-limited environment and resource utilization efficiency. However, if the radio resources for EPBCH candidate definition span small time-frequency dimension, there may be large loss of frequency diversity due to less radio resource distribution degree for EPBCH transmission.

### PRB-Pair Based EPBCH Physical Structure

In one embodiment, a PRB pair is utilized as a basic unit to define an EPBCH candidate. Within the radio resources for EPBCH candidate definition, there may be one or multiple PRB pairs reserved for EPBCH transmission. Single or several EPBCH candidates are defined based on the physical structure of PRB pairs and each candidate EPBCH has its own aggregation level utilizing a PRB pair as the basic unit. If the radio resources for EPBCH candidate definition span large enough time-frequency dimension, it is preferred to utilize distant PRB pairs in time-frequency domain for EPBCH transmission to support larger diversity. If the radio resources for EPBCH candidate definition span small time-frequency dimension, it is preferred to utilize one or nearby PRB pairs in time-frequency domain for EPBCH transmission to have a simple physical mapping design. Based on the cell coverage size, the supported aggregation level(s) for EPBCH transmission can vary.

FIG. 12 illustrates PRB pair based physical structure for EPBCH candidate definition. FIG. 12 illustrates two examples when nearby PRB pairs (e.g., PRB pairs 4 and 5 in FIG. 12(a)) and distant PRB pairs (e.g., PRB pairs 1 and 5 in FIG. 12(b)) in time-frequency domain are utilized for EPBCH transmission.

### EPBCH Search Space

EPBCH candidates for UE to detect EPBCH transmission constitute a search space. Single search space can be defined within the available radio resources and it is shared by all cells. Though it brings better scheduling flexibility, it would introduce higher UE blind decoding complexity and it may increase the latency of cell search. To minimize UE complexity, multiple EPBCH search spaces can be defined by grouping EPDCCH candidates and each cell has its own search space definition. Due to limited number of search space definitions, multiple cells may share one search space definition. Each search space may reside within orthogonal, partially overlapping or fully overlapping radio resources with others. Which search space to be used for a cell from UE perspective can be determined by its cell type, physical cell identification (PCI) or both.

To support different cell coverage sizes with minimal overhead, the predefined EPBCH candidates include EPBCH candidates using different aggregation levels to support different coding rates for different reliability levels. However, it would increase the number of EPBCH candidates within a search space for UE's blind decoding due to additional trials for different aggregation levels. This would introduce higher UE blind decoding complexity and it may increase the latency of cell search. To minimize UE complexity, the required aggregation level(s) for EPBCH transmission can depend on the cell type. Cell type information can be obtained from a predefined rule related to the PCI.

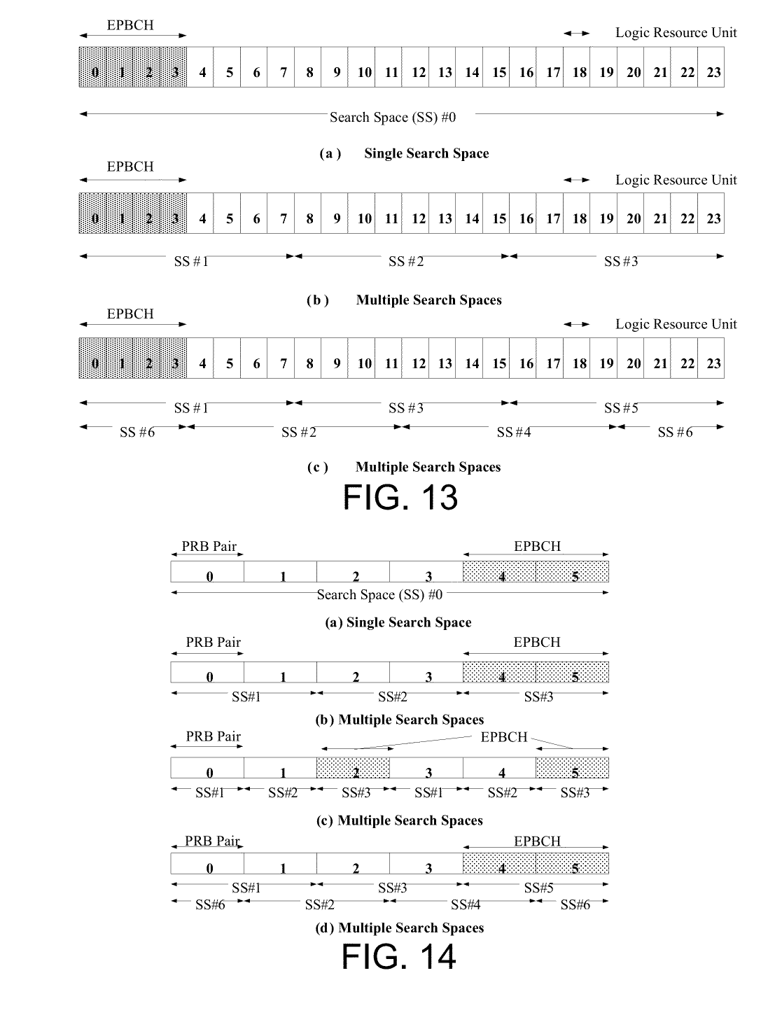

FIG. 13 illustrates different EPBCH search spaces in logic resource unit domain. In one embodiment, for minimal UE blind decoding complexity, the required aggregation level for EPBCH transmission can depend on the cell type, which can be obtained from a predefined rule related to the PCI. For example, UE only needs to search for EPBCH candidates with aggregation level eight (e.g., eight ECCE or EREG for one EPBCH candidate) when it tries to camp on a macrocell and EPBCH candidates with aggregation level two (e.g., two ECCE or EREG for one EPBCH candidate) when it tries to camp on a picocell. PCIs for macrocells and picocells are separated into different groups according to a predefined rule so that an UE can obtain the cell type information after the detection of the PCI. In addition, multiple EPBCH search spaces can be defined in logic resource unit domain to further reduce the number of EPBCH candidates UE has to blindly decode. FIG. 13 compares the cases with single and multiple search space definitions. FIG. 13(a) shows an example of single EPBCH search space defined in logic resource unit domain while FIGS. 13(b) and 13(c) show two examples of multiple EPBCH search spaces defined in logic resource unit domain. The resource unit can be either EREG or ECCE. Comparing FIGS. 13(a) and 13(b), UE blind decoding complexity is reduced due to smaller search space size. Comparing FIGS. 13(b) and 13(c), UE blind decoding complexity is the same but 13(c) creates more search spaces by allowing overlapping search spaces. Which search space to be used for a cell from UE perspective can be determined by its PCI.

FIG. 14 illustrates different EPBCH search spaces in PRB pair domain. In one embodiment, for minimal UE blind decoding complexity, the required aggregation level for EPBCH transmission can depend on the cell type, which can be obtained from a predefined rule related to the PCI. For example, UE only needs to search for EPBCH candidates with aggregation level eight (e.g., eight PRB pairs for one EPBCH candidate) when it tries to camp on a macrocell and EPBCH candidates with aggregation level two (e.g., two PRB pairs for one EPBCH candidate) when it tries to camp on a picocell. PCIs for macrocells and picocells are separated into different groups according to a predefined rule so that an UE can obtain the cell type information after the detection of the PCI. In addition, multiple EPBCH search spaces can be defined in PRB pair domain to further reduce the number of EPBCH candidates UE has to blindly decode. FIG. 14 compares the cases with single and multiple search space definitions and the difference between two PRB-pairs indices determines their time-frequency distance. FIG. 14(a) shows an example of single EPBCH search space defined in PRB pair domain while FIGS. 14(b), 14(c) and 14(d) show three examples of multiple EPBCH search spaces defined in PRB pair domain. Comparing FIGS. 14(a) and 14(b), UE blind decoding complexity is reduced due to smaller search space size. Comparing FIGS. 14(b) and 14(c), UE blind decoding complexity is reduced due to smaller search space size. Comparing FIGS. 14(b) and 14(d), UE blind decoding complexity is the same but 14(d) creates more search spaces by allowing overlapping search spaces. Which search space to be used for a cell from UE perspective can be determined by its PCI.

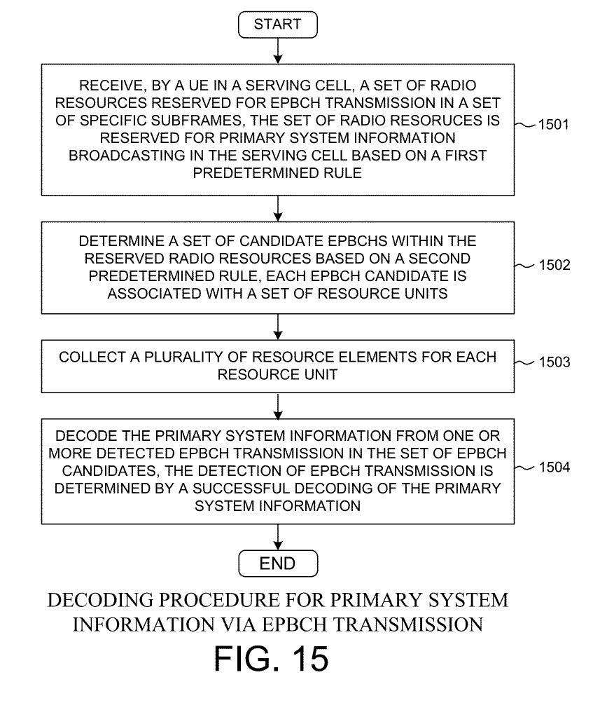

FIG. 15 is a flow chart of a method of receiving and decoding primary system information using EPBCH in accordance with one novel aspect. In step 1501, a UE in a serving cell receives a set of radio resources reserved for EPBCH transmission in a set of specific subframes. The set of radio resources is reserved for primary system information broadcasting in the serving cell based on a first predetermined rule. For example, the first determined rule is a function based on a physical cell ID (PCI) or a cell type of the serving cell. In step 1502, the UE determines a set of candidate EPBCHs within the reserved radio resources based on a second predetermined rule. For example, the second predetermined rule is a function based on a physical cell ID (PCI) or a cell type of the serving cell. Each EPBCH candidate is associated with a set of resource units. In one example, the resource unit is a PRB pair. In another example, the resource unit is an EREG. In yet another example, the resource unit is an ECCE, which may consist of EREGs. In step 1503, the UE collects a plurality of resource elements for each resource unit. In step 1504, the UE decodes the primary system information from one or more detected EPBCH transmission in the set of EPBCH candidates. The detection of EPBCH transmission is determined by a successful decoding of the primary system information.

EPBCH candidates for UE to detect EPBCH transmission constitute a search space. Single search space can be defined within the available radio resources and it is shared by all cells. Multiple EPBCH search spaces can be defined by grouping EPDCCH candidates and each cell has its own search space definition. To minimize UE complexity, the required aggregation level(s) for EPBCH transmission can depend on the cell type. For example, EPBCH aggregation level can be eight resource units for a macrocell and two resource units for a picocell. Cell type information can be obtained from a predefined rule related to the PCI.

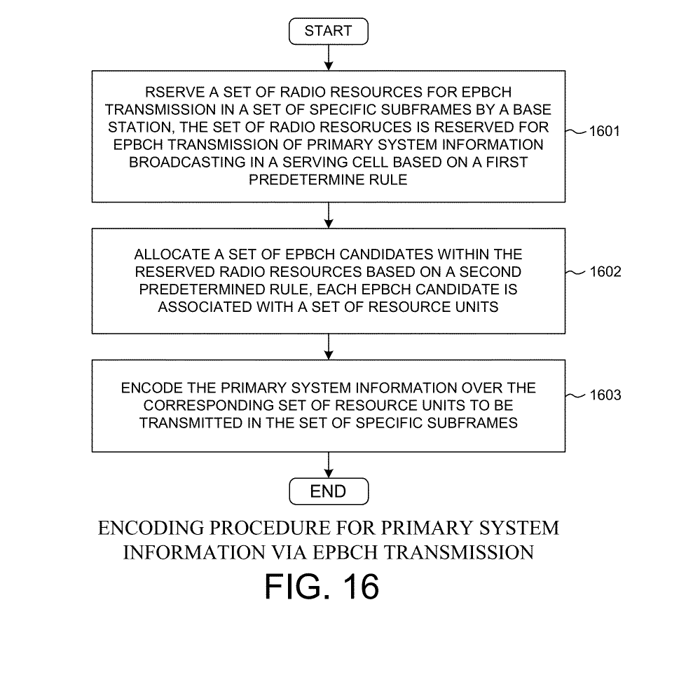

FIG. 16 is a flow chart of a method of encoding and transmitting primary system information using EPBCH in accordance with one novel aspect. In step 1601, a base station reserves a set of radio resources for EPBCH transmission in a set of specific subframes. The set of radio resources is reserved for EPBCH transmission of primary system information broadcasting in a serving cell based on a first predetermined rule. In step 1602, the base station allocates a set of EPBCH candidates within the reserved radio resources based on a second predetermined rule. Each EPBCH candidate is associated with a set of resource units. In step 1603, the base station encodes the primary system information over the corresponding set of resource units to be transmitted in the set of specific subframes.

Although the present invention has been described in connection with certain specific embodiments for instructional purposes, the present invention is not limited thereto. Accordingly, various modifications, adaptations, and combinations of various features of the described embodiments can be practiced without departing from the scope of the invention as set forth in the claims.

What is claimed is:

1. A method comprising:
(a) receiving, by a user equipment (UE) in a serving cell, a set of radio resources reserved for enhanced physical broadcast channel (EPBCH) transmission from a base station in a set of specific subframes, wherein the set of radio resources is reserved for primary system information broadcasting in the serving cell based on a first predetermined rule;
(b) determining a set of candidate EPBCHs within the reserved radio resources based on a second predetermined rule, wherein each EPBCH candidate is associated with a set of resource units;
(c) collecting a plurality of resource elements (REs) for each resource unit; and
(d) decoding the primary system information from one or more detected EPBCH transmission in the set of EPBCH candidates, wherein the detection of EPBCH transmission is determined by a successful decoding of the primary system information.

2. The method of claim 1, wherein the first predetermined rule is a function based on a physical cell ID (PCI) or a cell type of the serving cell.

3. The method of claim 1, wherein the second predetermined rule is a function based on a physical cell ID (PCI) or a cell type of the serving cell.

4. The method of claim 1, wherein each resource unit is a physical resource block (PRB) pair.

5. The method of claim 1, wherein each resource unit is an enhanced resource element group (EREG), and wherein each resource unit consists of a number of REs within a physical resource block (PRB) pair.

6. The method of claim 1, wherein each resource unit is an enhanced control channel element (ECCE), and wherein each resource unit consists of a number of REs within a physical resource block (PRB) pair.

7. The method of claim 1, wherein each resource unit is an enhanced control channel element (ECCE), and wherein each ECCE consists of a number of EREGs based on an EREG-to-ECCE mapping rule.

8. The method of claim 7, wherein the collecting in (c) involves:
collecting a plurality of EREGs for each ECCE; and
collecting the plurality REs for each EREG, wherein each EREG consists of a number of REs based on an RE-to-ERGE mapping rule.

9. The method of claim 1, wherein each EPBCH candidate is defined with different aggregation levels using a resource unit as a basic unit.

10. The method of claim 1, wherein each EPBCH candidate spans in frequency domain in one subframe.

11. The method of claim 1, wherein each EPBCH candidate spans in both frequency domain and in time domain in different subframes.

12. The method of claim 1, wherein the set of EPBCH candidates is a full set of all available EPBCH candidates within the reserved radio resources.

13. The method of claim 1, wherein the set of EPBCH candidates is a subset of all available EPBCH candidates within the reserved radio resources.

14. A method comprising:
(a) reserving a set of radio resources for enhanced physical broadcast channel (EPBCH) transmission in a set of specific subframes by a base station, wherein the set of radio resources is reserved for primary system information broadcasting in a serving cell based on a first predetermined rule;
(b) allocating a set of EPBCH candidates within the reserved radio resources based on a second predetermined rule, wherein each EPBCH candidate is associated with a set of resource units; and
(d) encoding the primary system information over the corresponding set of resource units to be transmitted in the set of specific subframes.

15. The method of claim 14, wherein the first predetermined rule is a function based on a physical cell ID (PCI) or a cell type of the serving cell.

16. The method of claim 14, wherein the second predetermined rule is a function based on a physical cell ID (PCI) or a cell type of the serving cell.

17. The method of claim 14, wherein each resource unit is a physical resource block (PRB) pair.

18. The method of claim 14, wherein each resource unit is an enhanced resource element group (EREG), and wherein each resource unit consists of a number of REs within a physical resource block (PRB) pair.

19. The method of claim 14, wherein each resource unit is an enhanced control channel element (ECCE), and wherein each resource unit consists of a number of REs within a physical resource block (PRB) pair.

20. The method of claim 14, wherein each resource unit is an enhanced control channel element (ECCE), and wherein each ECCE consists of a number of EREGs based on an EREG-to-ECCE mapping rule, and wherein each EREG consists of a number of REs based on an RE-to-ERGE mapping rule.

21. The method of claim 14, wherein each EPBCH candidate is defined with different aggregation levels using a resource unit as a basic unit.

22. The method of claim 14, wherein each EPBCH candidate spans in frequency domain in one subframe.

23. The method of claim 14, wherein each EPBCH candidate spans in both frequency domain and in time domain in different subframes.

24. The method of claim 14, wherein the set of EPBCH candidates is a full set of all available EPBCH candidates within the reserved radio resources.

25. The method of claim 14, wherein the set of EPBCH candidates is a subset of all available EPBCH candidates within the reserved radio resources.
